(19) United States
(12) Patent Application Publication
(10) Pub. No.: US 2006/0256668 A1
(43) Pub. Date: Nov. 16, 2006

(54) Magnetooptic head

(75) Inventors: Hiroyasu Yoshikawa, Kawasaki (JP); Tsuyoshi Matsumoto, Kawasaki (JP); Goroh Kawasaki, Kawasaki (JP); Nobuyuki Kanto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/413,515

(22) Filed: Apr. 28, 2006

Related U.S. Application Data
(63) Continuation of application No. PCT/JP03/14164, filed on Nov. 6, 2003.

(51) Int. Cl. G11B 11/00

(52) U.S. Cl. 369/13.07

(57) ABSTRACT

A magnetooptic head includes a lens (11b) which forms a beam spot on a disc, a magnetic field generating coil (2) between the lens (11b) and the disc, and a magnetic layer (3) between the coil (2) and the lens (11b). The magnetic layer (3) is provided by a plurality of magnetic members (30) disposed radially of an optical axis of the lens (11b). The magnetic layer (3) and the lens (11b) are mediated by a thermal conduction layer (5), and the thermal conduction layer (5) is provided, integrally therewith, a thermal conduction section (50) which extends a space between mutually adjacent magnetic members (30) in the magnetic layer (3), for reception of heat.

This is a continuation of International Application No. PCT/JP2003/014164, filed Nov. 6, 2003.

### TECHNICAL FIELD

The present invention relates to magnetooptic heads used in recording/reproducing data to and from magnetooptic discs.

### BACKGROUND ART

JP-A 2003-51144 Gazette, for example, discloses a magnetooptic head which uses magnetic field modulation method. The magnetooptic head disclosed in the Gazette includes a lens which forms a laser spot on a disc, a coil placed between the lens and the disc for generation of a magnetic field, and a magnetic layer placed between the coil and the lens. The coil generates heat when an electric current is applied to the coil. In order to remove the heat from the coil efficiently, the head disclosed in the gazette makes use of a radiator layer which surrounds the outer circumference of the coil. According to this arrangement, the radiator layer improves heat removal as it is cooled by an airflow generated when the disc is turning.

However, the arrangement is not sufficient yet as will be explained below, in improving heat removal.

In the magnetic field modulation method, a high frequency current of e.g. 50 MHz flows through the magnetic field generation coil. The coil generates a magnetic field, and the range of magnetic field distribution is deformed by a magnetic layer so the magnetic field works efficiently in a direction toward the disc. In this process, the magnetic flux which penetrates the magnetic layer changes its direction in the magnetic layer, and an eddy current generates to cancel the directional change. The eddy current turns into heat and increases the temperature of the magnetic layer.

The magnetic field generated in the coil also works on the radiator layer which surrounds the coil outer circumference. Then, an eddy current generates in the radiator layer according to the directional change of the magnetic flux. As a result, this eddy current turns into heat to degrade the characteristic (heat removal) of the radiator layer.

Such temperature rise in the magnetic layer or such characteristic degradation in the radiator layer causes heat inflow to the lens. This leads to shift in an optical characteristic such as the refraction index of the lens. So there has still been room for improvement for increased heat removal, including removal of heat caused by the eddy currents.

### DISCLOSURE OF THE INVENTION

It is therefore an object of the present invention to provide a magnetooptic head capable of increasing removal of heat including heat caused by eddy current.

A first aspect of the present invention provides a magnetooptic head which includes: a lens for formation of a beam spot on a disc; a coil placed between the lens and the disc for generating a magnetic field; and a magnetic layer between the coil and the lens. The magnetic layer includes a plurality of magnetic members arranged radially around the optical axis of the lens. Between the magnetic layer and the lens is provided a thermal conduction layer for reception of heat. The thermal conduction layer is formed integral with a thermal conduction section which extends into a space between the magnetic members in the magnetic layer, for reception of heat.

According to a preferred embodiment, a radiator layer for releasing heat generated in the coil is provided around the coil. The radiator layer and the thermal conduction layer are integral with each other.

A second aspect of the present invention provides a magnetooptic head which includes: a lens for formation of a beam spot on a disc; a coil placed between the lens an the disc for generating a magnetic field; a magnetic layer between the coil and the lens; and a radiator layer surrounding the coil for releasing heat generated in the coil. The magnetic layer includes a plurality of magnetic members arranged radially around the optical axis of the lens. A thermal conduction member for reception of heat is provided between the magnetic members in the magnetic layer. The radiator layer and the thermal conduction member are integral with each other.

A third aspect of the present invention provides a magnetooptic head which includes: a lens for formation of a beam spot on a disc; a coil placed between the lens and the disc for generating a magnetic field; a magnetic layer between the coil and the lens; and a radiator layer surrounding the coil for releasing heat generated in the coil. A thermal conduction layer for reception of heat is provided between the magnetic layer and the lens. The radiator layer and the thermal conduction layer are integral with each other.

According to a preferred embodiment, the magnetic layer comprises a plurality of magnetic members disposed radially around the optical axis of the lens.

According to a preferred embodiment, the thermal conduction layer is divided radially with the optical axis of the lens as a center.

According to a preferred embodiment, the radiator layer is divided radially with the optical axis of the lens as a center.

Other features and advantages of the present invention will become clearer from the following detailed description to be made with reference to the attached drawings.

### BRIEF DESCRIPTION OF THE DRAWINGS

FIG. 1 is a sectional view showing a primary portion of an embodiment of the present invention.

FIG. 2 is an enlarged sectional view of a primary portion in FIG. 1.

FIG. 3 is an enlarged perspective view of a primary portion in FIG. 1.

FIGS. 4A-4F are a series of sectional views of a primary portion, showing steps of forming different layers.

FIGS. 5A-5D are a series of sectional views of a primary portion, showing steps of forming different layers.

FIG. 6 shows a simulation result comparing a case where a thermal conduction layer was provided to a case where it was not.

FIG. 7 is an enlarged perspective view of a primary portion, showing another embodiment of the present invention.

FIG. 8 is an enlarged perspective view of a primary portion, showing still another embodiment of the present invention.

FIG. 9 is an enlarged perspective view of a primary portion, showing still another embodiment of the present invention.

FIG. 10 is an enlarged perspective view of a primary portion, showing still another embodiment of the present invention.

### BEST MODE FOR CARRYING OUT THE INVENTION

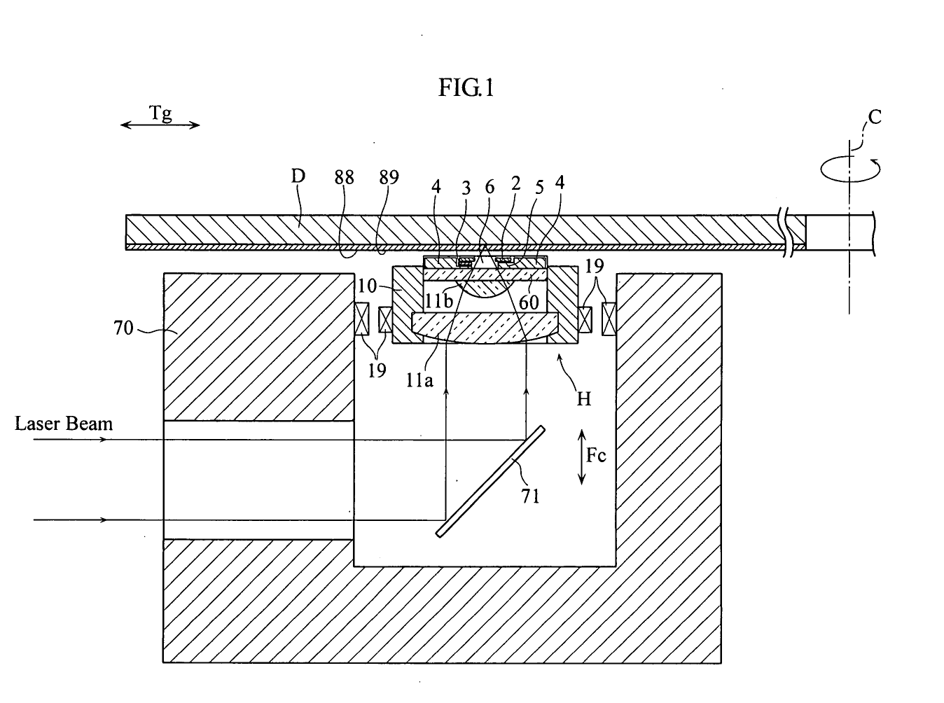

FIGS. 1 through 3 show an embodiment of the present invention. As shown clearly in FIG. 1, a magnetooptic head H according to the present embodiment includes a lens holder 10, two objective lenses 11a, 11b held by the lens holder 10, a magnetic field generating coil 2, a magnetic layer 3, a radiator layer 4, a thermal conduction layer 5 and a dielectric film 6.

As shown in FIG. 1, the lens holder 10 is mounted at a carriage 70 and is placed below a magnetooptic disc D. The lens holder 10 is supported by the carriage 70 via supporting means (not illustrated) which produces moves in the tracking direction of the magnetooptic disc D (i.e. radially) as indicated by Arrow Tg, and therefore can move in this direction. Further, the lens holder 10 is driven by e.g. electromagnetic driving means 19 and is capable of moving in the focusing direction indicated by Arrow Fc. The lens holder 10 is provided with two objective lenses 11a, 11b which are spaced from each other by a predetermined distance. One objective lens 11b which is located closer to the magnetooptic disc D is bonded to the lower surface of a transparent rectangular substrate 60, and is supported by the lens holder 10 integrally with the substrate 60. The coil 2, the magnetic layer 3, the radiator layer 4, the thermal conduction layer 5 and the dielectric film 6 are formed at the upper side of the substrate 60.

The magnetooptic disc D is driven by an unillustrated spindle motor and rotates at a high speed about an axis indicated in FIG. 1 by Phantom Line C. The magnetooptic disc D has a recording layer 88 on one surface facing the lens holder 10 of the two surfaces of the magnetooptic disc D (See FIG. 1). The recording layer 88 has its surface coated with a transparent and insulating protection film 89.

The carriage 70 is driven by e.g. an unillustrated voice coil motor and is capable of moving in the tracking direction Tg. This movement of the carriage 70 is involved in a seek operation which is an operation of bringing the lens holder 10 close to a target track. The laser beam comes from a fixed optical unit which includes an unillustrated laser diode and a collimating lens toward the carriage 70 to reach an erection mirror 71 mounted in the carriage 70. The laser beam then reflects on the erection mirror 71 in an upward direction, enters the objective lenses 11a, 11b successively to converge, thereby forming a laser spot on the recording layer 88. The fixed optical unit also includes a beam splitter and an optical detector so the laser beam reflected by the recording layer 88 is then detected by the optical detector.

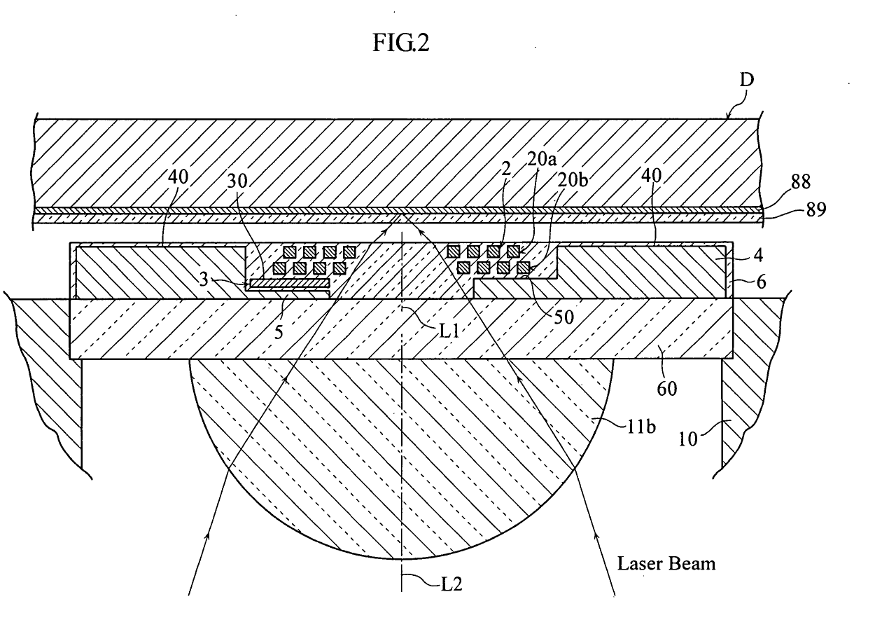

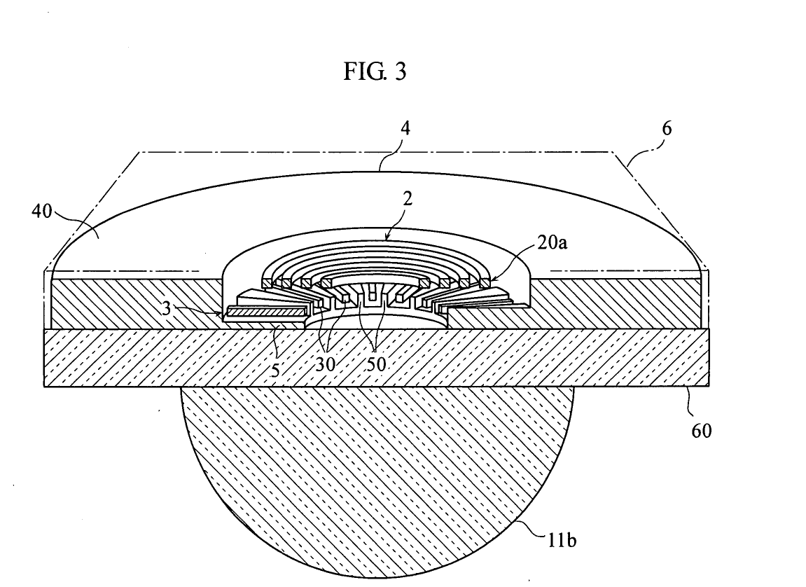

As shown clearly in FIG. 2 and FIG. 3, the magnetic field generating coil 2 is formed on the transparent substrate 60 to which the objective lens 11b is bonded. This substrate 60 is made of e.g. the same glass as of the objective lens 11b, and is bonded tightly to the objective lens 11b so that there will not be any gap developed on the border plane between the substrate 60 and the objective lens 11b.

The coil 2 is formed by patterning a film of metal such as copper into a predetermined shape, and can be formed by semiconductor manufacturing process. The coil 2 has e.g. two layers of conductor films 20a, 20b (Note that the conductor film 20b which is closer to the objective lens 11b is not illustrated in FIG. 3). These two conductor films 20a, 20b have a spiral shape to form a spiral coil. The coil 2 is placed in a manner such that its center axis L1 substantially accords with an optical axis L2 of the objective lens 11b and thereby the coil 2 does not block the laser beam which has passed the objective lens 11b. In the coil 2, each of the conductor films 20a, 20b has a part extended to a side edge of the dielectric film 6 and substrate 60, serving as a power supply terminal (not illustrated) for the coil 2. Also, the two conductor films 20a, 20b have respective parts on the inner circumferential side which are connected to each other (not illustrated) for electrical conduction. As shown clearly in FIG. 2 and FIG. 3, the magnetic layer 3 is provided below the coil 2, and below the magnetic layer 3 is the thermal conduction layer 5.

The magnetic layer 3, which is made of e.g. Permalloy, serves to deform the distribution pattern of the magnetic field generated by the coil 2 so that the magnetic field works efficiently in a direction toward the magnetooptic disc D. As shown clearly in FIG. 3, the magnetic layer 3 includes a plurality of magnetic members 30 placed radially around the optical axis L2 of the objective lens 11b (i.e. the center axis L1 of the coil 2). The magnetic members 30 have an elongated shape and can be formed by semiconductor manufacturing process. The magnetic member 30 are placed on the same plane and substantially equi-spaced from each other without making contact with the radiator layer 4 or the thermal conduction layer 5. Each magnetic member 30 is surrounded by the dielectric film 6, so the space between two mutually adjacent magnetic members 30 is mediated by the dielectric film 6 while allowing part of the thermal conduction layer 5 extending therein. Such part of the thermal conduction layer 5 that extends into the space between two magnetic members 30 will be called a thermal conduction section 50 in the present embodiment.

The radiator layer 4 is made of a metal which has a higher thermal conductivity than the dielectric film 6, such as copper. In the present embodiment, the radiator layer 4 releases heat generated by the coil 2 and the magnetic layer 3 as well as heat conducted from the thermal conduction layer 5. As shown clearly in FIG. 2 and FIG. 3, the radiator layer 4 has a hollow cylindrical shape and surrounds the outer circumference of the coil 2 and magnetic layer 3. With the above, the radiator layer 4 has an inner circumferential portion which is below the coil 2, connected and integrated with the thermal conduction layer 5 (including the thermal conduction section 50). Part of the dielectric film 6 coats an upper surface 40 of the radiator layer 4 which faces the magnetooptic disc D. The upper surface 40 of the radiator layer 4 as described is formed to be as close as possible to the magnetooptic disc D for efficient heat radiation to the outside. It should be noted that the upper surface of the radiator layer may be exposed out of the surface of the dielectric film.

The thermal conduction layer 5, which is made of e.g. the same copper material as of the radiator layer 4, is provided for efficient reception of heat which transfers from the coil 2 toward the substrate 60 and the lens 11b. As shown clearly in FIG. 3, the thermal conduction layer 5 is provided to cover the entire bottom surface of the magnetic layer 3. The thermal conduction section 50 of the in the thermal conduction layer 5 is as high as to reach the upper surface of the magnetic layer 3, extending into gaps between the equi-spaced magnetic members 30. With such a construction as the above, the thermal conduction layer 5 receives heat generated in the coil 2, and transfers it to the radiator layer 4, while receiving heat generated in each magnetic member 30 by eddy current (more to be described about this later) and transferring it to the radiator layer 4.

The dielectric film 6 is made of a translucent dielectric material such as aluminum oxide and silicon oxide, and is formed on the substrate 60 to cover the coil 2, the magnetic layer 3, the radiator layer 4 and the thermal conduction layer 5. The coil 2, the magnetic layer 3 and the radiator layer 4 are insulated from each other by the dielectric film 6 which mediates between them. The magnetic members 30 of the magnetic layer 3 and the thermal conduction sections 50 of the thermal conduction layer 5 are also insulated from each other by the dielectric film 6 which mediates in between. Being as the above, the dielectric film 6 preferably has a refraction index which is substantially the same as of the substrate 60 or of the objective lens 11b. It should be noted that in FIG. 3, the dielectric film 6 is outlined in phantom lines.

The coil 2, the magnetic layer 3, the radiator layer 4, the thermal conduction layer 5 and the dielectric film 6 can be formed by semiconductor manufacturing process, as follows:

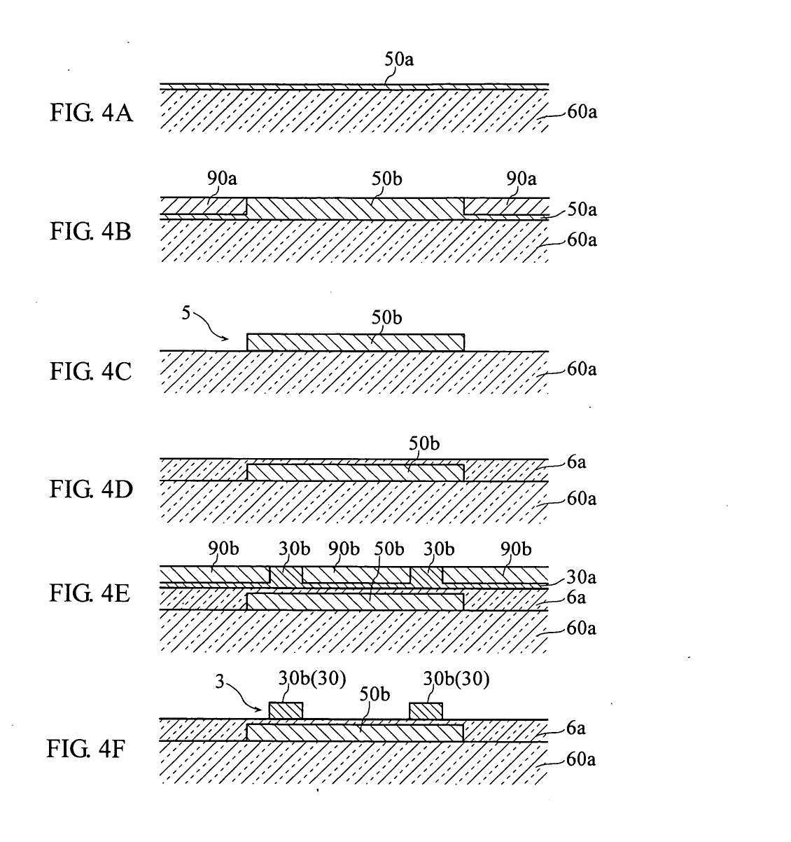

First, as shown in FIG. 4A, a first base layer 50a of copper is formed by sputtering or vapor deposition on a base or a substrate 60a (part of the substrate 60). The first base layer 50a is made of e.g. titanium-chromium, and has a thickness in the order of nanometer. Next, as shown in FIG. 4B, a film of a first resist 90a is applied on the first base layer 50a, and an exposure and a development processes are conducted. Subsequently, a copper layer 50b is formed through growing copper by e.g. plating on the areas where the resist 90a does not cover the surface of the first base layer 50a. Next, as shown in FIG. 4C, the first resist 90a is removed and thereafter, ion milling, for example, is conducted to blast the surface of copper layer 50b while removing unnecessary portion of the first base layer 50a. This step yields a lower portion of the thermal conduction layer 5 (portions except the thermal conduction section). After the formation of the layer 50b of copper which is to be the lower portion of the thermal conduction layer 5, a step similar to the above is performed to form a radiator layer 4 in contact with the side surface of the copper layer 50b.

Next, as shown in FIG. 4D, a dielectric layer 6a (part of the dielectric film 6) is formed by sputtering, to cover surfaces of the substrate 60a and of the copper layer 50b. Thereafter, CMP (chemical-mechanical polishing) process is performed to flatten the surface of the dielectric layer 6a. Next, as shown in FIG. 4E, a base layer 30a and a Permalloy layer 30b of the magnetic members 30 are formed on the surface of the dielectric layer 6a. The base layer 30a is made of the same material as of the Permalloy layer 30b or otherwise titanium-chromium. The base layer 30a and Permalloy layer 30b as the above can be formed by steps similar to those illustrated in FIG. 4A and FIG. 4 (b), i.e. through patterning a second resist pattern 90b, coating, exposing, developing, plating and so on. Next, as shown in FIG. 4F, the second resist 90b is removed and thereafter, ion milling, for example, is conducted to blast the surface of Permalloy layer 30b while removing unnecessary portion of the base layer 30a. This step yields all the magnetic members 30 of the magnetic layer 3.

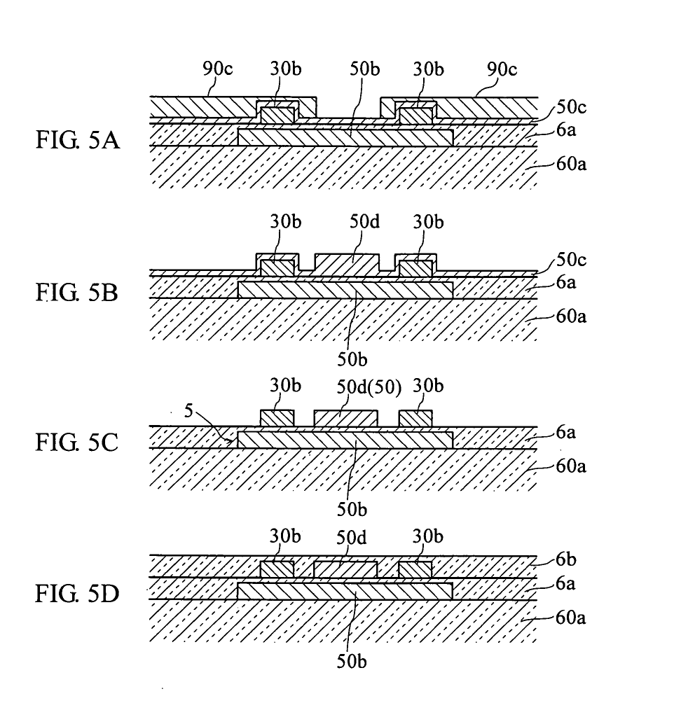

Next, as shown in FIG. 5A, a second base layer 50c of copper is formed by sputtering or vapor depositing, to cover surfaces of the dielectric layer 6a and of the Permalloy layer 30b. Thereafter, a film of a third resist 90c is applied on the second base layer 50c, except the region between mutually adjacent blocks of the Permalloy layer 30b, and then an exposure and a development processes are performed. Next, as shown in FIG. 5B, plating for example is performed to grow a layer of copper on a surface of the second base layer 50c which is not covered with the third resist 90c (i.e. the region between mutually adjacent blocks of the Permalloy layer 30b), to form a copper layer 50d. Thereafter, the third resist 90c is removed. The copper layer 50d has a thickness in the order of nanometer. Next, as shown in FIG. 5C, ion milling, for example, is conducted to blast the surface of copper layer 50d while removing unnecessary portion of the second base layer 50c. This step yields the thermal conduction section 50 of the thermal conduction layer 5. Now, the lower portion of the thermal conduction layer 5 represented by the copper layer 50b and the thermal conduction section 50 represented by the copper layer 50d are insulated from each other since there is the dielectric layer 6a between the two. The dielectric layer 6a which mediates between the copper layers 50b, 50d as described above is significantly thinner than the copper layer 50b, 50d. Therefore, these copper layers 50b, 50d are virtually integral with each other and conduct heat very well to each other.

Then, in order to form the coil 2, as shown in FIG. 5D, a dielectric layer 6b (part of the dielectric film 6) is formed by sputtering, to cover surfaces of the dielectric layer 6a and the copper layer 50d. Thereafter, CMP process is performed to flatten the surface of the dielectric layer 6b. Then, by performing two cycles of the above-described series of steps, i.e. patterning and coating of a resist pattern, exposing and developing processes, plating, sputtering and CMP processes to form a dielectric layer, and so on, the coil 2 which has a two-layer structure provided by the conductor films 20a, 20b is formed.

Next, description will cover function of the magnetooptic head H.

In the present embodiment, magnetic field modulation method is used as a method for writing data to the magnetooptic disc D. When writing data to the magnetooptic disc D by means of magnetic field modulation method, a laser beam is applied intermittently onto a target track in the recording layer 88 while the magnetooptic disc D is rotated, whereby a specific magnetic material in the recording layer 88 is heated up to its Curie temperature. Meanwhile, a high frequency current of 20 MHz or of a higher frequency is applied to the coil 2 to alter the direction of magnetic field. Through these operations, magnetizing direction of the magnetic material in the recording layer 88 is controlled.

The magnetic field generated by the coil 2 as described works efficiently in the direction toward the magnetooptic disc D as the magnetic field distribution range is deformed by the magnetic layer 3. In the magnetic layer 3, the magnetic flux penetrates each magnetic member 30 in its longitudinal direction. On the other hand, there is little magnetic flux which penetrates the thermal conduction layer 5 including the thermal conduction sections 50 since magnetic flux is concentrated to the nearby magnetic members 30. Due to such a magnetic flux direction change as this, eddy current is generated in each magnetic member 30 to counter the magnetic flux. The eddy current turns into heat and increases the temperature of each magnetic member 30. The heat due to eddy current as the above is received mainly by the thermal conduction sections 50 together with the heat generated in the coil 2, and then conducted efficiently to the thermal conduction layer 5. Thus, the heat does not transfer very much to the objective lens 11b or the substrate 60.

The heat received by the thermal conduction layer 5 then is efficiently conducted to the radiator layer 4. The radiator layer 4 also receives the heat generated at the coil 2. As the magnetooptic disc D rotates, a high speed air flow is generated between the radiator layer 4 and the magnetooptic disc D. Though covered by part of the dielectric film 6, the upper surface 40 of the radiator layer 4 is placed as close as possible to the magnetooptic disc D and so is cooled positively by the high speed air flow. Therefore, heat which comes from the thermal conduction layer 5 and the coil 2 to the radiator layer 4 easily moves toward the upper surface 40 of the radiator layer 4, and is released efficiently from the upper surface 40 of the radiator layer 4 to the outside (in the air).

As described, most of the heat generated in the coil 2 and heat generated by the eddy current move to the thermal conduction layer 5 or the radiator layer 4, and eventually dissipated effectively through the upper surface 40 of the radiator layer 4. For this reason, it is possible to increase heat removal around the coil 2 even if there is heat generation by the eddy current. Heat around the coil 2, especially heat near the thermal conduction layer 5, is removed efficiently, and as a result, there is reduced heat affect to the objective lens 11b and/or the substrate 60. Thus, there is no risk that the heat will alter optical characteristics, e.g. refraction index, of the objective lens 11b and the substrate 60. This makes possible to form a laser spot at a proper size and position on the recording layer 88 of the magnetooptic disc D, which then enables to increase accuracy in data recording.

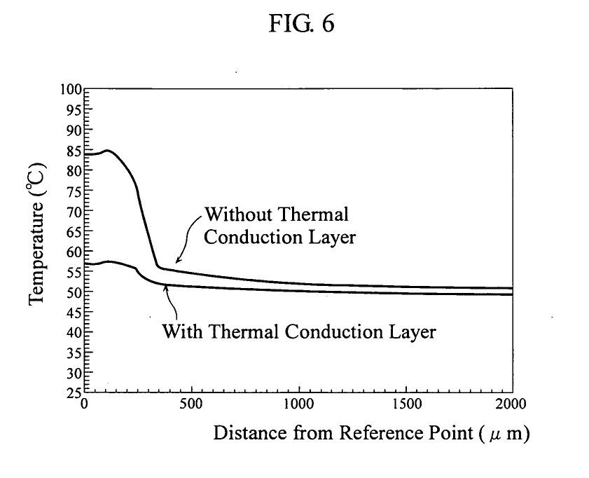

For a reference, FIG. 6 shows a result of simulation which compared a case which makes use of a thermal conduction layer to a case which does not. The simulation assumed that the ambient temperature was a constant temperature of 25° C. The horizontal axis represents the distance (μm) from a reference point to a hypothetical temperature measuring points whereas the vertical axis represents the temperature (°C.). The reference point was a point in the coil on its center axis. From this reference point, hypothetical temperature measuring points were picked radially of the coil. As shown in the figure, when there is no thermal conduction layer provided, a maximum temperature increase of approximately 60° C. is anticipated at a point where the highest extreme is expected. This was confirmed in actual measurements, and in fact the actual measurements found almost exactly the same values as the simulation results. On the other hand, when a thermal conduction layer is provided, a maximum anticipated temperature increase is only 30° C. from the ambient temperature. Therefore, it can be easily gathered that use of a thermal conduction layer will remarkably improve heat removal over cases where there is no use thereof.

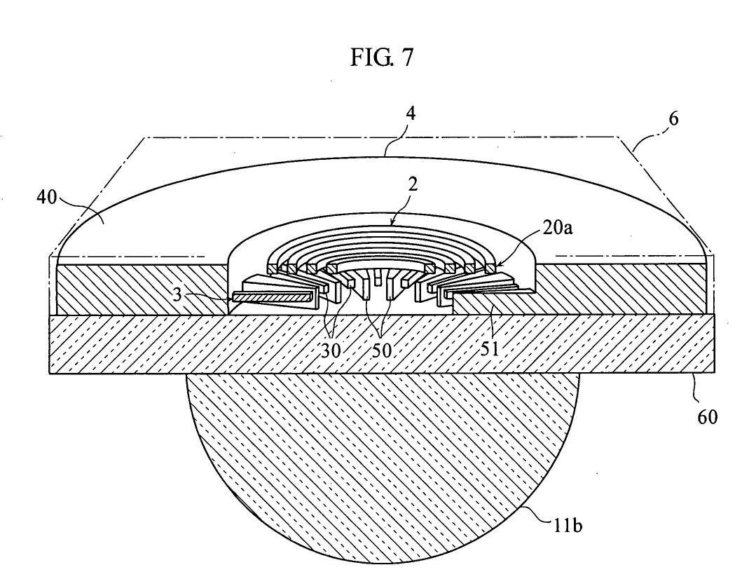

FIGS. 7 through 10 show other embodiments of the magnetooptic head according to the present invention. In these figures, elements which are identical with or similar to those used in the above-described embodiment are indicated by the same reference codes.

FIG. 7 shows a structure in which two mutually adjacent magnetic members 30 are mediated by a thermal conduction member 51 of the same material as of a radiator layer 4. The thermal conduction member 51 is columnar between the magnetic members 30 to reach the upper surface of the substrate 60, and is integrally connected with the inner circumferential wall of the radiator layer 4. The thermal conduction member 51 as described conducts heat generated in the coil 2 to the radiator layer 4, as well as conducting heat generated by eddy current in each magnetic member 30 to the radiator layer 4.

According to a structure such as the above, heat from the coil 2 and magnetic members 30 is conducted to the thermal conduction member 51, and so does not very much to the objective lens 11b or the substrate 60. The heat received by the thermal conduction member 51 then transfers efficiently to the radiator layer 4. The heat received by the thermal conduction member 51 then moves efficiently to the radiator layer 4, and dissipates to the outside from an upper surface 40 of the radiator layer 4. Therefore, a construction such as the above is also capable of increasing heat removal, and is suitable for reducing the influence of the heat on the objective lens 11b and the substrate 60.

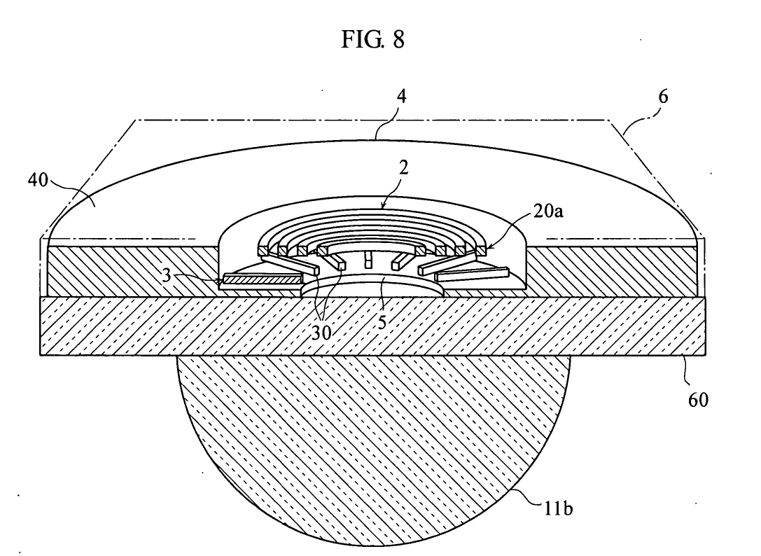

FIG. 8 shows a construction in which a thermal conduction layer 5 covers only the entire bottom surface of the magnetic layer 3. In other words, two mutually adjacent magnetic members 30 are mediated only by a dielectric film 6. The thermal conduction layer 5 as described above efficiently receives heat from the coil 2 through between the magnetic members 30, as well as conducting heat generated by eddy current in each magnetic member 30 to the radiator layer 4. Therefore, a construction such as the above is also capable of increasing heat removal, and is suitable for reducing the influence of the heat on the objective lens 11b and the substrate 60.

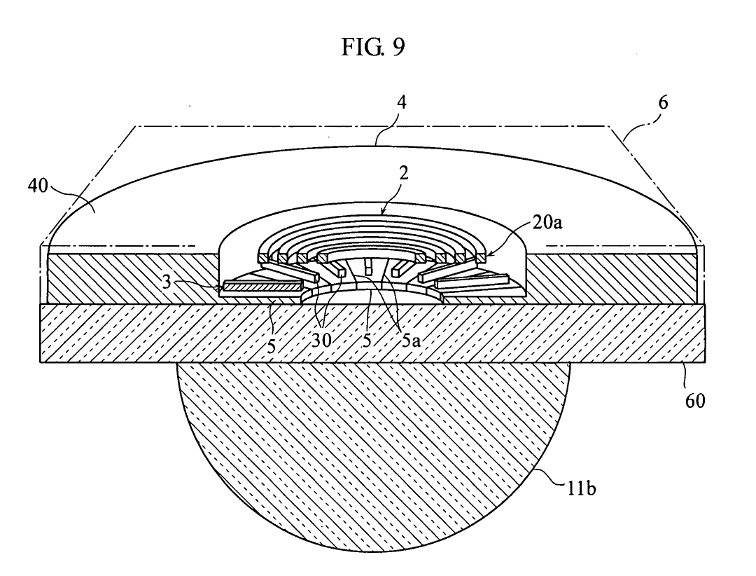

FIG. 9 shows a construction in which a thermal conduction layer 5 covers only the entire bottom surface of the magnetic layer 3 and in addition, is divided radially about the optical axis of the objective lens 11b (the center axis of the coil 2). In other words, the thermal conduction layer 5 is formed with dividing gaps 5a radially of the coil 2.

According to such a construction as the above, the thermal conduction layer 5 is penetrated slightly by magnetic flux, which generates a small amount of eddy current in the thermal conduction layer 5. However, since the thermal conduction layer 5 is divided into pieces by the gaps 5a, the eddy current only occurs in separation, in individually divided portions of the thermal conduction layer 5, and the amount of the eddy current as a back flow is limited to a relatively small amount. Therefore, heat generation in the thermal conduction layer 5 due to the eddy current is limited to a small amount as possible, and heat removal is promoted accordingly.

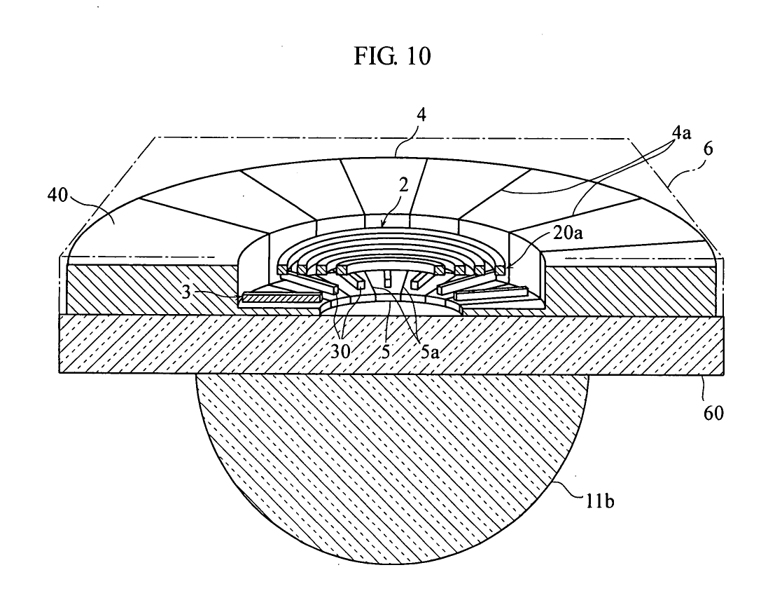

FIG. 10 shows a construction in which a radiator layer 4 and a thermal conduction layer 5 are divided radially about the optical axis of the objective lens 11b (the center axis of the coil 2). In other words, the radiator layer 4 and the thermal conduction layer 5 are respectively formed with dividing gaps 4a, 5a radially of the coil 2.

According to such a construction as the above, the thermal conduction layer 5 and the radiator layer 4 are penetrated slightly by magnetic flux, so a small amount of eddy current is generated in the thermal conduction layer 5 and the radiator layer 4. However, as described earlier, the eddy current can occur only in separated portions of the thermal conduction layer 5 and radiator layer 4, and the amount of the eddy current as a back flow is limited to a relatively small size. Therefore, according to a construction such as the above, heat generation due to the eddy current is limited to a small amount as possible, and heat removal is promoted accordingly.

It should be noted that the scope of the present invention is not limited to the embodiments described hereinabove. Specific constitution of each part and components of the magnetic head according to the present invention may be varied in many different ways.

For example, a magnetooptic head according to the present invention may include a slider which floats slightly off the magnetooptic disc, and the coil may be provided in the slider. Further, although manufacture of the coil, the magnetic layer, the radiator layer, the thermal conduction layer (thermal conduction member) and the dielectric film are easy to in the form of films by using semiconductor manufacturing processes, the method of manufacture is not limited to this.

1. A magnetooptic head comprising: a lens for formation of a beam spot on a disc; a coil placed between the lens and the disc for generating a magnetic field; and a magnetic layer between the coil and the lens;
wherein the magnetic layer includes a plurality of magnetic members arranged radially around an optical axis of the lens,
wherein a thermal conduction layer is provided between the magnetic layer and the lens for reception of heat,
wherein the thermal conduction layer is formed integral with a thermal conduction section for reception of heat that extends into a space between the magnetic members of the magnetic layer.

2. The magnetooptic head according to claim 1, further comprising a radiator layer arranged around the coil for releasing heat generated in the coil, wherein the radiator layer and the thermal conduction layer are integral with each other.

3. A magnetooptic head comprising: a lens for formation of a beam spot on a disc; a coil placed between the lens and the disc for generating a magnetic field; a magnetic layer between the coil and the lens; and a radiator layer surrounding the coil for releasing heat generated in the coil;
wherein the magnetic layer includes a plurality of magnetic members arranged radially around an optical axis of the lens,
wherein a thermal conduction member for reception of heat is provided between the magnetic members of the magnetic layer,
wherein the radiator layer and the thermal conduction member are integral with each other.

4. A magnetooptic head comprising: a lens for formation of a beam spot on a disc; a coil placed between the lens and the disc for generating a magnetic field; a magnetic layer between the coil and the lens; and a radiator layer surrounding the coil for releasing heat generated in the coil;
wherein a thermal conduction layer for reception of heat is arranged between the magnetic layer and the lens,
wherein the radiator layer and the thermal conduction layer are integral with each other.

5. The magnetooptic head according to claim 4, wherein the magnetic layer comprises a plurality of magnetic members arranged radially around an optical axis of the lens.

6. The magnetooptic head according to claim 4 or 5, wherein the thermal conduction layer is divided radially with the optical axis of the lens as a center.

7. The magnetooptic head according to claim 6, wherein the radiator layer is divided radially with the optical axis of the lens as a center.
